(19) United States
(12) Patent Application Publication
(10) Pub. No.: US 2015/0364820 A1
(43) Pub. Date: Dec. 17, 2015

(54) MULTIBAND ANTENNA APPARATUS AND METHODS

(71) Applicant: QUALCOMM Incorporated, San Diego, CA (US)

(72) Inventors: Yuandan Dong, San Diego, CA (US); Jatupum Jenwatanavet, San Diego, CA (US); Allen Minh-Triet Tran, San Diego, CA (US)

(21) Appl. No.: 14/303,840

(22) Filed: Jun. 13, 2014

(51) Int. Cl. H01Q 5/30; H01Q 5/10; H01Q 5/20

(52) U.S. Cl. CPC H01Q 5/30; H01Q 5/20; H01Q 5/10

(57) ABSTRACT

The present disclosure includes multiband antenna apparatus and methods. In one embodiment, an antenna includes a loop antenna having a first corner between a first side and a second side and a second corner between the second side and a third side, a loop fed inverted F antenna comprising the loop antenna and a first arm extending from the second corner of the loop antenna, the first arm configured in parallel with the first and second sides of the loop antenna and forming a corner proximate to the first corner of the loop antenna, and a monopole antenna coupled to the first side of the loop antenna.

### BACKGROUND

The present disclosure relates to multiband antenna apparatus and methods.

An antenna is an electrical component that converts electrical energy into radio waves and vice versa. An antenna is typically coupled to a receiver for receiving and processing RF signals, a transmitter for sending RF signals, or both. During reception, the antenna senses RF waves and produces voltages that can be sensed by a low noise amplifier, for example. During transmission, AC current radiates energy and the electrical waveforms from the transmitter propagate out as RF waves.

Particular antenna designs typically operate over a particular range of frequencies (a frequency band). In some cases, it may be desirable to send and receive frequencies over multiple frequency bands spread over a wide range of frequencies. For example, cellular mobile devices may include multiple antennas tuned for different frequency bands. However, developing a single antenna structure that can operate well over multiple frequency bands is challenging.

### SUMMARY

The present disclosure includes multiband antenna apparatus and methods. In one embodiment, an antenna includes a loop antenna having a first corner between a first side and a second side and a second corner between the second side and a third side, a loop fed inverted F antenna comprising the loop antenna and a first arm extending from the second corner of the loop antenna, the first arm configured in parallel with the first and second sides of the loop antenna and forming a corner proximate to the first corner of the loop antenna, and a monopole antenna coupled to the first side of the loop antenna. The proposed antennas may have a compact corner structure and are size efficient.

The following detailed description and accompanying drawings provide a better understanding of the nature and advantages of the present disclosure.

### BRIEF DESCRIPTION OF THE DRAWINGS

FIG. 1 illustrates a multiband antenna according to one embodiment.

FIGS. 2A-C illustrate components of the multiband antenna of FIG. 1.

FIG. 3 illustrates S-parameters of an example implementation of two multiband antennas according to one embodiment.

FIG. 4 illustrates a device including a board with multiple multiband antennas according to one embodiment.

FIG. 5 shows a perspective of two multiband antennas according to one embodiment.

FIG. 6 shows a perspective of multiple multiband antennas according to one embodiment.

FIGS. 7A-C show antenna efficiency performance across particular frequency bands for multiple multiband antennas according to one embodiment.

FIG. 8 illustrates a method according to one embodiment.

FIG. 9 illustrates a method of forming an antenna according to one embodiment.

### DETAILED DESCRIPTION

The present disclosure pertains to multiband antennas. In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

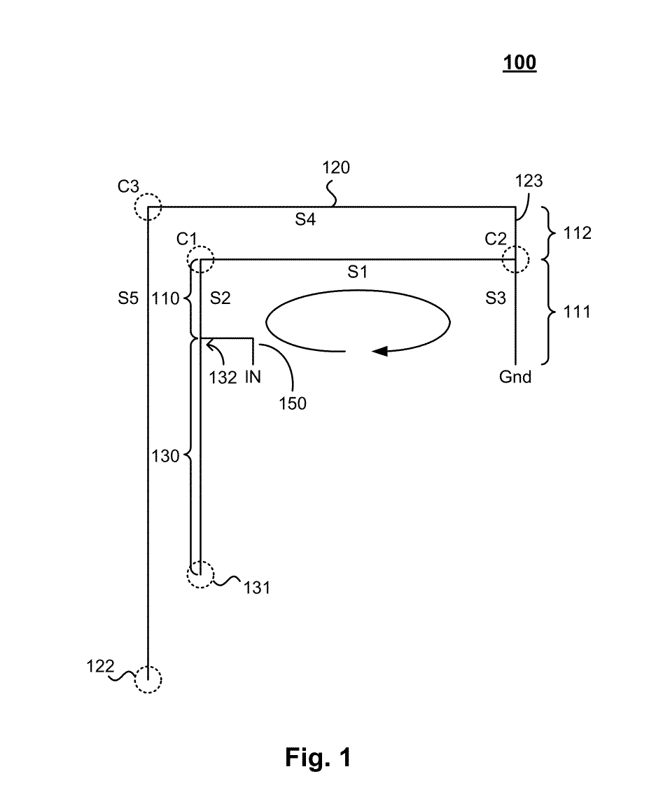

FIG. 1 illustrates a multiband antenna structure 100 according to one embodiment. Multiband antenna structure 100 comprises a loop antenna, a loop fed inverted F antenna (i.e., loop fed “IFA”), and a monopole antenna. The loop antenna includes sides S1, S2, and S3 coupled between an antenna input port (IN) and ground (GND). Sides S1 and S2 meet to form a corner C1. Similarly, sides S1 and S3 meet to form another corner C2. In this example, sides S1, S2, and S3 are approximately flat surfaces, as illustrated in more detail below.

In this example, the loop fed IFA includes the loop antenna itself (described above) and an arm 120 extending from the corner C2 of the loop antenna. As shown in FIG. 1, side S3 of the loop antenna extends along a length 111. In this example, arm 120 is coupled to loop antenna corner C2 along a length 112 comprising an extension piece 123 of arm 120. One side S4 of arm 120 is configured in parallel with side S1 of the loop antenna, and another side S5 of arm 120 is configured in parallel with side S2 of the loop antenna. Sides S4 and S5 of arm 120 meet to form a corner C3 proximate to corner C1 of the loop antenna. Arm 120 extends from corner C3 to terminal end 122.

Multiband antenna 100 further includes a monopole antenna 130. Monopole antenna 130 is coupled to side S2 of the loop antenna and extends in line with side S2 of the loop and in parallel with side S5 of arm 120 of the loop fed IFA. In one embodiment, the grounded loop sides S3, S1, and S2 provide a large inductance which can be neglected at the operating frequency for the monopole. Monopole 130 shares an input feed with the loop antenna. Monopole 130 extends starting at a proximate end 132 at an end of length 110 of side S2 of the loop antenna to a terminal end 131. In this example, terminal end 122 of arm 120 of the loop fed IFA extends beyond the terminal end 131 of the monopole antenna 130. The input feed may include conductive material between input (IN) and proximate end 132 of monopole 130 and side S2 of the loop. Accordingly, monopole 130 may share the input feed part with the loop antenna, for example.

In this example, multiband antenna includes an input port (IN) coupled to a point between the length 110 of side S2 of the loop antenna and a proximate end 132 of the monopole antenna 130. In this example, input port (IN) is coupled to the loop antenna and monopole antenna by a connection element 150 (e.g., a conductive stub) arranged at a right angle. The opposite end of the loop antenna on side S3 is coupled to ground (GND).

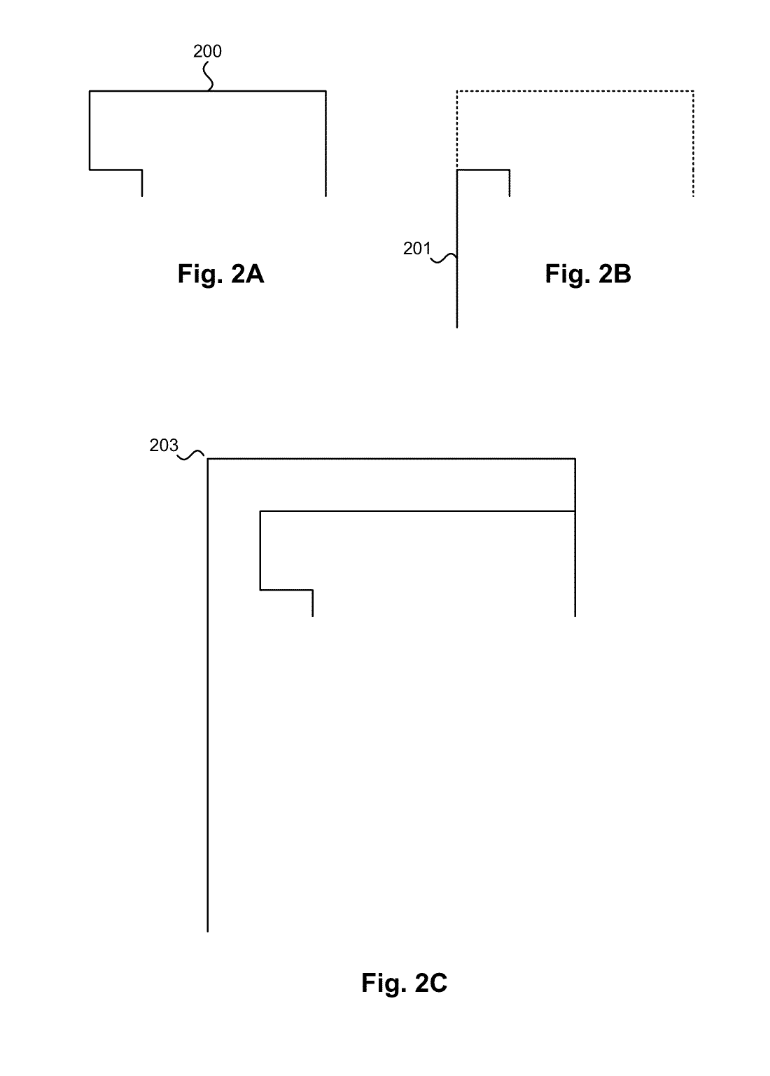

FIGS. 2A-C illustrate components of the multiband antenna of FIG. 1. In these example diagrams, the composite structure in FIG. 1 is broken down into separate resonance elements for illustrative purposes. FIG. 2A shows a loop antenna 200 resonance structure. FIG. 2B illustrates the monopole 201 and input feed coupled to the loop antenna (loop in dashed lines). FIG. 2C illustrates the loop fed IFA (e.g., the loop and the arm without the monopole).

Loop antenna, loop fed IFA, and monopole antenna of multiband antenna 100 form a composite antenna configured to respond to multiple frequency bands. While the composite structure may include three resonance structures, connecting each resonant structure into one composite structure changes their resonant nature and mutual interaction may improves matching, for example, which contributes to multiband and wideband performance. In one embodiment, multiband antenna 100 may respond to a first frequency band, a second frequency band above the first frequency band, and a third frequency band above the second frequency band. Multiband antenna may respond to a fourth frequency band above the third frequency band in one example implementation described below.

The loop, IFA, and monopole resonators described above may contribute to different frequency bands. For example, the IFA may contribute to a low frequency band, while the monopole may mainly contribute to a middle frequency band. Finally, the loop may be mainly responsible for the two high bands. In one embodiment, the antenna may be tuned by changing the various dimensions. For example, increasing the monopole length could shift the middle frequency band, which may be nominally between 1700-2700 MHz. Moreover, in one embodiment, four equivalent antennas may enable the feature of antenna switch (or exchange), making the device able to assign any antenna to work on any particular frequency band at any time. Accordingly, different antennas may be assigned to process different frequency bands at different times, for example. In some embodiments, the antennas may work simultaneously to achieve higher data rate. For example, in one embodiment illustrated below, four antennas are assigned to process the same frequency band at the same time. In one embodiment, particular frequencies processed by one antenna can be switched to other antennas while working.

In one embodiment, the antenna is self-matched and may not require extra matching components, although matching components may be used to further improve performance and increase flexibility in some applications.

Typically, matching components are formed by inductors and capacitors, and are associated with some degree of loss, which would reduce the efficiency. But they are able to shift the frequency, extend the bandwidth, and improve the return loss. In many cases, antennas are designed without the matching circuit. Embodiments of the present antennas can be self-matched because they can use internal coupling and transmission lines to accomplish the matching. Different resonating structures can provide the required inductors or capacitors. The different resonating structures are mutual interacted which can provide the required matching. For instance, the side S3 of the loop may also serve as the shunt inductor (grounded part) for the IFA, for example.

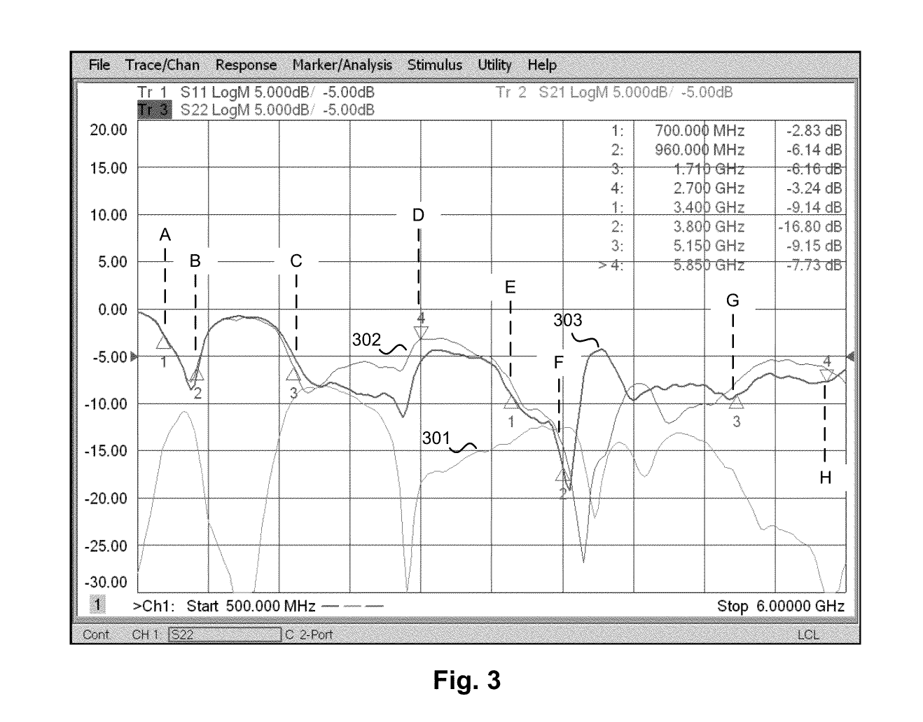

FIG. 3 illustrates S-parameters of an example implementation of a multiband antenna according to one embodiment. There are four similar antennas in total on the four corners. This example plot shows the 2-port S-parameters S11, S21, and S22 from 500 MHz to 6 GHz, where S11 is the input port voltage reflection coefficient for one antenna, S21 is the coupling between the two antennas, or forward voltage gain, and S22 is the output port voltage reflection coefficient, or input port voltage reflection coefficient for the other antenna. The plot shows frequency bands of improved responsiveness to RF signals where the forward voltage gain 301 (S21), or coupling, is small, the input reflection 302 (S11) decreases, and the output reflection 303 (S22) decreases. For example, in this example implementation, improved S-parameter characteristics are shown between frequency bands between frequencies 700 MHz (marked A) and 960 MHz (B), 1.7 GHz (C) and 2.7 GHz (D), 3.4 GHz (E) and 3.8 GHz (F), and 5.15 GHz (G) and 5.85 GHz (H).

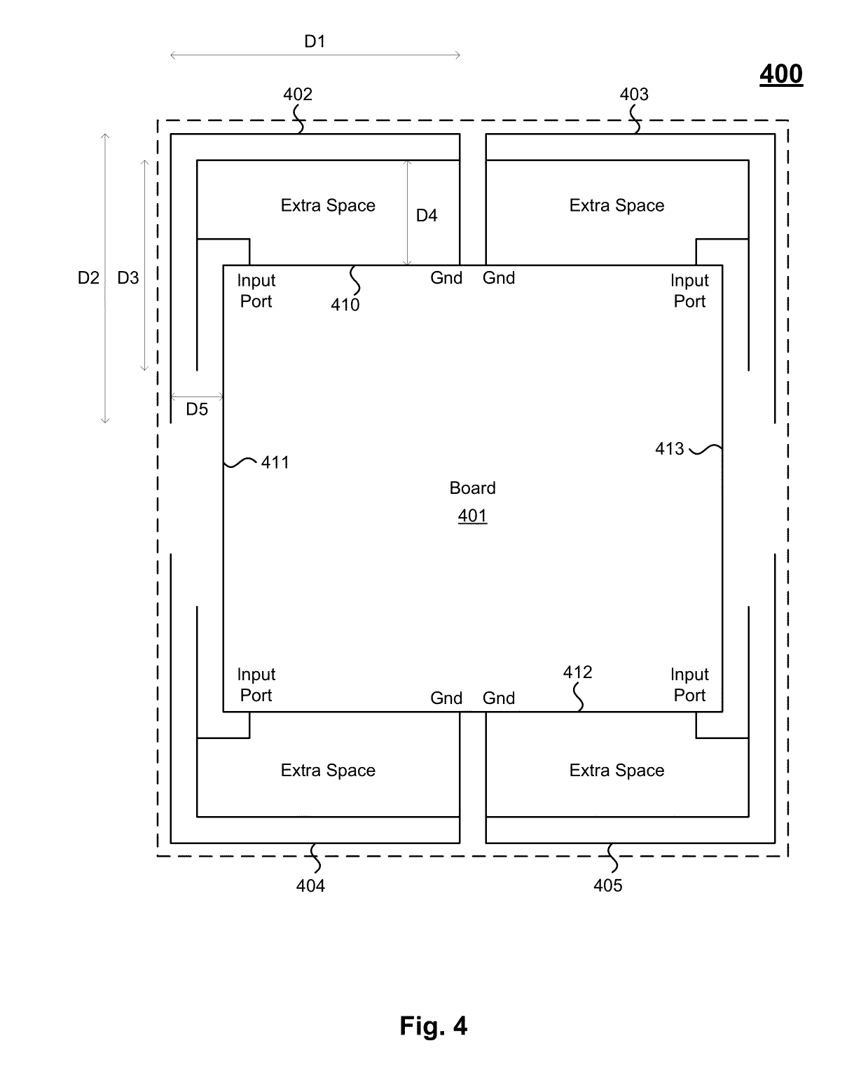

FIG. 4 illustrates a device 400 including a board with multiple multiband antennas according to one embodiment. Device 400 may be a mobile communications system such as a smart phone or tablet computer, for example. Board 401 may be a main board for a wireless device, for example, which may provide a ground for antennas. In one embodiment, board 401 is a multi-layer printed circuit board (PCB), for example. Features and advantages of the present disclosure include a multiband antenna structure that may be arranged around multiple corners of a rectangular shaped device, for example, with efficient use of space. For instance, in this example a rectangular board 401 (e.g., a main board of a wireless handheld device) may include four (4) multiband antennas 402-405 described herein arranged on four board corners between four sides 410-413 of the board. As illustrated in FIG. 4, the corners of the loop antenna and the arm of the loop fed IFA allow the multiband antenna structures to be configured on corners of board 401. Extra space may be created naturally within the sides of the loop antenna and the edge of the board 401, which allows room in the device for placement of accessories and other components such as display, USB, camera, audio jack, and/or other circuitry. Particular embodiments may include electronic components arranged in the space between the sides of the board (e.g., board sides 410 and 412) and the second side of the loop antenna (parallel to the board sides).

Multiple antenna structures may be useful carrier aggregation applications where multiple antennas (e.g., 4 antennas) work simultaneously across a wide frequency range. In one embodiment, two of the top side antennas are used for diversity antennas, which are for receiving only. In some applications, all antennas may be used for receiving, but only bottom antennas are used for transmitting for radiation concerns. For carrier aggregation applications, all frequency bands may be used for receiving, but only part of the bands may be used for transmitting signals, such as the cellular band and PCS band, for example. Example frequency ranges for carrier aggregation applications include a first band from 700-960 MHz, a second band from 1700-2700 MHz (e.g., 1850-1990 MHz for PCS), a third band from 3400-3800 MHz, and a fourth band from 5100-5900 MHz, for example.

FIG. 4 also illustrates example dimensions for one example implementation. Length of the arm from the loop to the arm corner, D1, which is approximately the same dimension as the upper loop side may be 26 mm, for example. The length of the arm from the corner to the terminal end, D2, may be 48 mm, for example. The length of the monopole (and outer side of the loop), D3, may be 21 mm, for example. A distance from an edge of the board to the upper loop side, D4, may be 10 mm, for example, which may be slightly smaller than the distance to the arm since the distance between the upper loop side and arm may be relatively small. Finally, a distance from the edge of the board to the arm, D5, may be 2 mm, for example, which may be similar to the distance to the monopole since the distance between the monopole and the arm may be relatively small. The dimensions of all four antennas may be substantially identical in some applications, for example. The gap between each component inside the antenna (i.e., the gap between top loop side and arm of the IFA and the gap between IFA and monopole) may be small, such as 0.5 mm, for example. These gaps can affect the antenna loading and adjust the resonant frequency, for example.

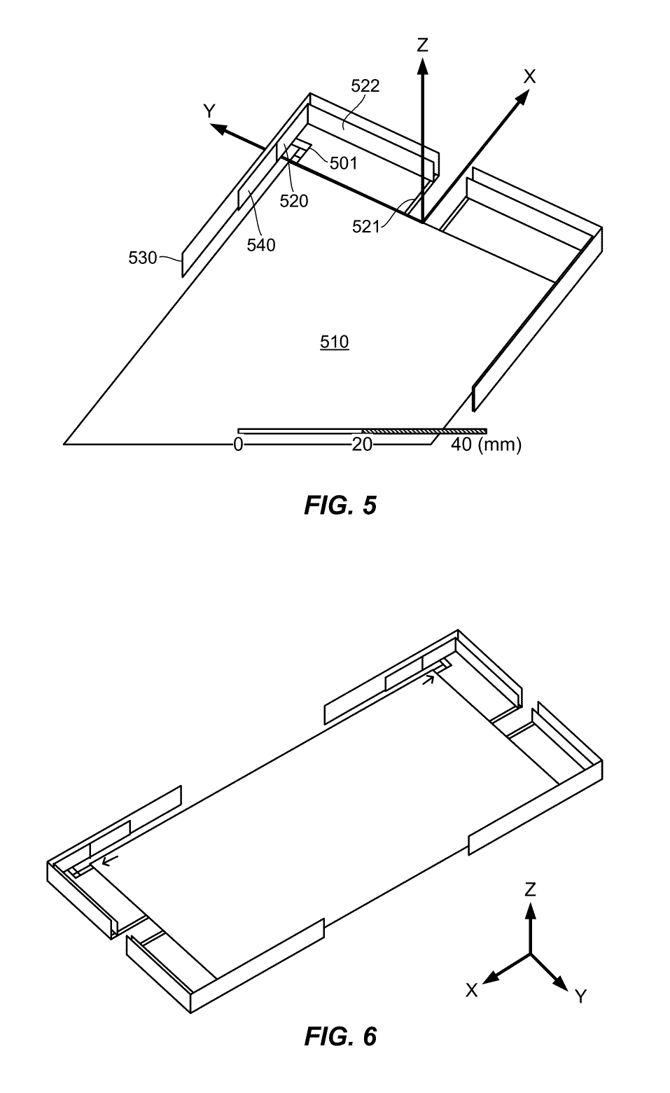

FIG. 5 shows a perspective of two multiband antennas according to one embodiment. This example shows one implementation of two antenna structures on the same side. In this example, a connection stub 501 is used to physically connect the board 510 to an outer side 520 of the loop and monopole 540. The connection stub 501 is flat and in the same plane as the board 510, creating space inside the device that extends beyond the board very close to the device edges. Similarly, the opposite side 521 of the loop is used to physically connect to board 501. Stub 501 may be electrically connected to circuitry for sending and receiving signals from the antenna, and side 521 may be electrically connected to ground, for example. Side 521 of the loop is also flat and in the same plane as board 501 to create space and limit obstructions to other components inside the device. Along the outer edges of the device, the monopole 540, the outer side 520 and upper side 522 of the loop, and the arm 530 of the loop fed IFA are planar surfaces perpendicular to the board and may be configured along the edge of the device, for example. FIG. 6 shows a perspective of multiple multiband antennas on four corners of a device. In one embodiment, four equivalent antennas enable the feature of an antenna switch (or exchange), making the device able to assign any antenna to work on any particular frequency band at any time, for example. One some embodiments, antenna may comprise the chassis (e.g., an outer surface) of a device's housing so that the antennas could reuse the mechanical housing. For example, the housing or the top and bottom edges of the phone may be the antenna radiator surfaces that are directly exposed to outside of the device. While the above example structures are shown in particular planes, it is to be understood that other arrangements may be used. For example, connection stub 501 may be in the same plane as the board, but could be in another plane. Similarly, the other components of the antenna may be in one or more other planes.

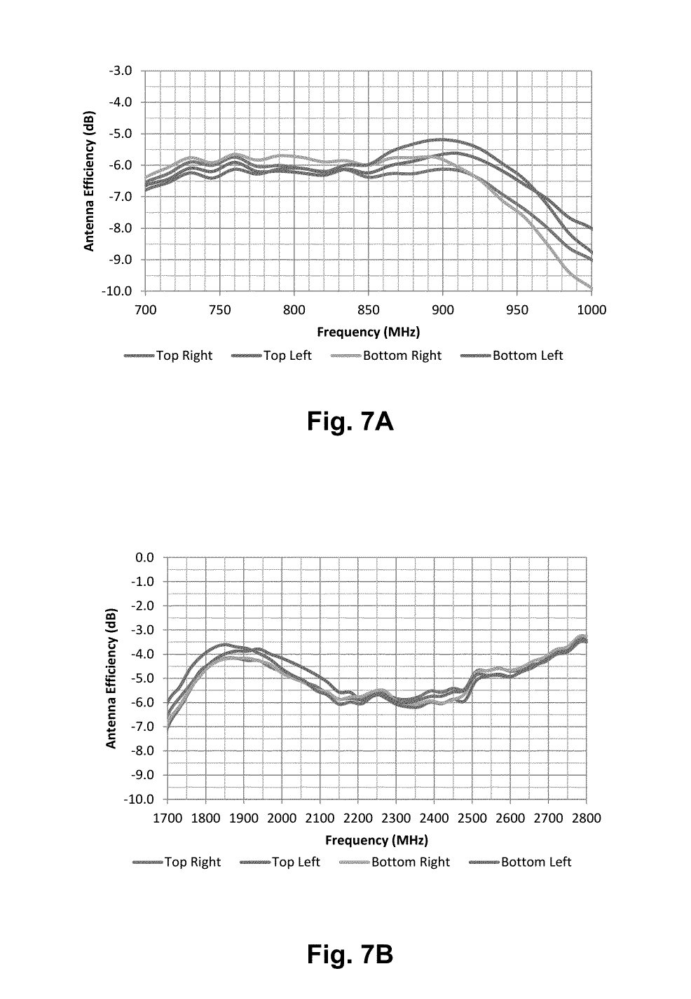

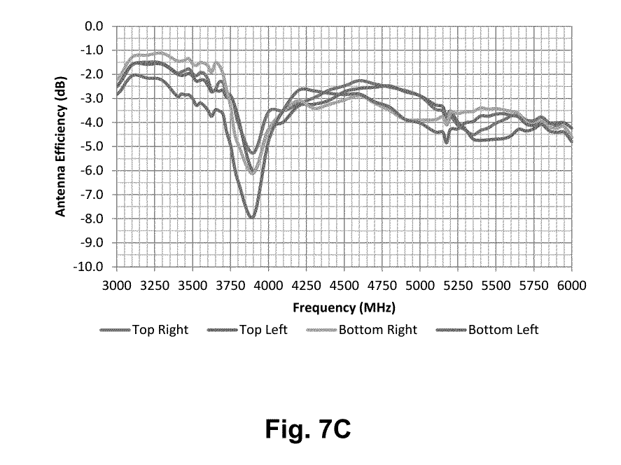

FIG. 7A-C show antenna efficiency performance across particular frequency bands for multiple multiband antennas according to one embodiment. The following plots may correspond to radiation efficiency tested with the phone battery and LCD screen, for example. FIG. 7A shows antenna efficiency performance of the composite multiband antennas on the top right, top left, bottom right, and bottom left for frequency band between 700 MHz and 960 MHz. The antennas all show an average 6 dB performance across the frequency band. FIG. 7B shows antenna efficiency performance of the composite multiband antennas on the top right, top left, bottom right, and bottom left for frequency band between 1700 MHz and 2700 MHz. Here, the antennas all show an average −5 dB performance across this frequency band. FIG. 7C shows antenna efficiency performance of the composite multiband antennas on the top right, top left, bottom right, and bottom left for frequencies from 3000 MHz to 6000 MHz. Here, the antennas show an average −3 dB efficiency for the frequency band from 3400 MHz to 3800 MHz, and an average −4 dB efficiency from 5 GHz to 6 GHz.

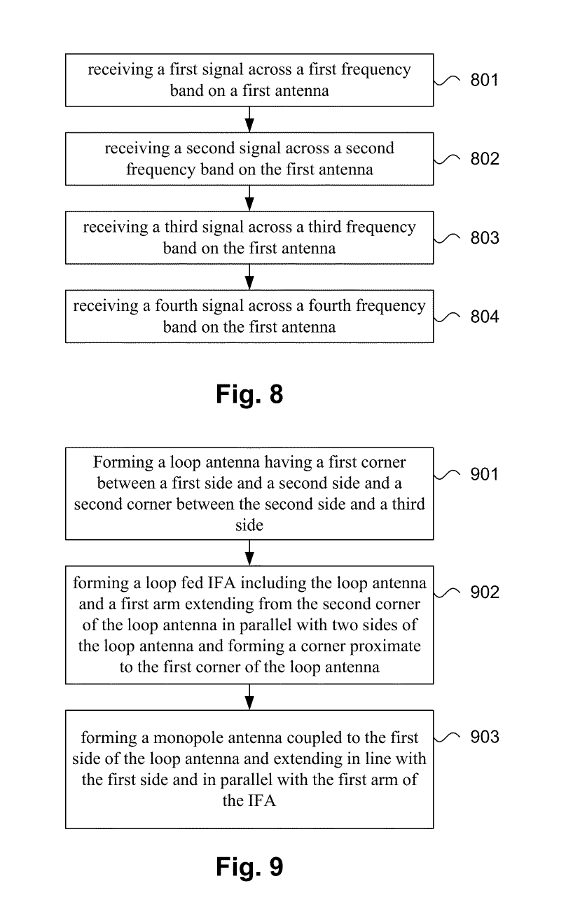

FIG. 8 illustrates a method according to one embodiment. At 801, a system may receive a first signal across a first frequency band on a first antenna. The first antenna may be configured as described above for multiband reception. At 802, the system may receive a second signal across a second frequency band on the first antenna. At 803, the system may receive a third signal across a third frequency band on the first antenna. Likewise, at 804, the system may receive a fourth signal across a fourth frequency band on the first antenna. As illustrated below, these process steps may occur simultaneously. For example, carrier aggregation is to enable the aggregation of different spectrum fragments. For carrier aggregation, all the bands may be working simultaneously. This allows the expansion of effective bandwidth delivered to a user terminal through concurrent utilization of radio resources across multiple carriers. Multiple component carriers are aggregated to form a larger overall transmission bandwidth. Note that the antennas described herein may have four bands, for example, and the aggregation could happen inside each band since there may be several carriers inside each band, it could also happen within different bands.

FIG. 9 illustrates a method of forming an antenna according to one embodiment. At 901, a loop antenna is formed having a first corner between a first side and a second side and a second corner between the second side and a third side. At 902, a loop fed inverted F antenna is formed including the loop antenna and a first arm extending from the second corner of the loop antenna, the first arm configured in parallel with the second side of the loop antenna and in parallel with the first side of the loop antenna and forming a corner proximate to the first corner of the loop antenna. At 903, a monopole antenna is formed coupled to the first side of the loop antenna and extending in line with the first side and in parallel with the first arm of the loop fed IFA.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An antenna comprising:
a loop antenna having a first corner between a first side and a second side and a second corner between the second side and a third side;
a loop fed inverted F antenna comprising the loop antenna and a first arm extending from the second corner of the loop antenna, the first arm configured in parallel with the second side of the loop antenna and in parallel with the first side of the loop antenna and forming a corner proximate to the first corner of the loop antenna; and
a monopole antenna sharing an input port with the loop antenna, the monopole antenna coupled to the first side of the loop antenna and extending in parallel with the first arm of the loop fed inverted F antenna.

2. The antenna of claim 1 wherein the first arm of the loop fed inverted F antenna extends beyond a terminal end of the monopole antenna.

3. The antenna of claim 1 wherein the input port is coupled to a point between the first side of the loop antenna and a proximate end of the monopole antenna.

4. The antenna of claim 1 wherein the third side of the loop antenna is shorted to ground.

5. The antenna of claim 1 wherein the first side and the second side of the loop antenna and the first arm of the loop fed inverted F antenna are approximately flat surfaces.

6. The antenna of claim 5 wherein the first side and the second side of the loop antenna are in a first plane and the third side of the loop antenna is in a second plane.

7. The antenna of claim 1 wherein said antenna is configured to respond to multiple frequency bands including a first frequency band and a second frequency band above the first frequency band.

8. The antenna of claim 7 wherein said antenna is configured to respond to a third frequency band above the second frequency band.

9. The antenna of claim 8 wherein said antenna is configured to respond to a fourth frequency band above the third frequency band.

10. The antenna of claim 9 wherein said antenna is configured to respond to frequencies within the range of 700 megahertz to 960 megahertz, 1700 megahertz to 2700 megahertz, 3400 megahertz to 3800 megahertz, and 5100 megahertz to 5900 megahertz.

11. An apparatus comprising:
a board comprising a first side, a second side, a third side and a fourth side, wherein the first side forms a first board corner with the second side, the second side forms a second board corner with the third side, the third side forms a third board corner with the fourth side, and the fourth side forms a fourth board corner with the first side, and wherein the first side and third side are approximately parallel and the second side and fourth side are approximately parallel; and
a plurality of antennas formed on the two or more of the first board corner, the second board corner, the third board corner, and the fourth board corner, each of the plurality of antennas comprising:
a loop antenna having a first corner between a first side and a second side and a second corner between the second side and a third side;
a loop fed inverted F antenna comprising the loop antenna and a first arm extending from the second corner of the loop antenna, the first arm configured in parallel with the second side of the loop antenna and in parallel with the first side of the loop antenna and forming a corner proximate to the first corner of the loop antenna; and
a monopole antenna sharing an input port with the loop antenna, the monopole antenna coupled to the first side of the loop antenna and extending in parallel with the first arm of the inverted F antenna.

12. The apparatus of claim 11 wherein said plurality of antennas are four antennas formed on the first board corner, the second board corner, the third board corner, and the fourth board corner.

13. The apparatus of claim 12 wherein different antennas are assigned to process different frequency bands at different times.

14. The apparatus of claim 12 wherein multiple antennas are assigned to process the same frequency bands at the same time.

15. The apparatus of claim 12 wherein said apparatus switches between antennas to process particular frequencies.

16. The apparatus of claim 11 wherein said apparatus is an electronic device, and wherein the first arm of each antenna forms an outer edge of a housing of the electronic device.

17. A method comprising:
receiving a first signal across a first frequency band at an input of an antenna, the antenna comprising a loop antenna, a loop fed inverted F antenna, and a monopole antenna, the loop antenna having a first corner between a first side and a second side and a second corner between the second side and a third side, the loop fed inverted F antenna comprising the loop antenna and a first arm extending from the second corner of the loop antenna, the first arm configured in parallel with the second side of the loop antenna and in parallel with the first side of the loop antenna and forming a corner proximate to the first corner of the loop antenna, and the monopole antenna coupled to the first side of the loop antenna and extending in parallel with the first arm of the loop fed inverted F antenna;
receiving a second signal across a second frequency band at the input of the antenna; and
receiving a third signal across a third frequency band at the input of the antenna.

18. The method of claim 17 further comprising receiving a fourth signal across a fourth frequency band at the input of the antenna.

19. The method of claim 18 wherein said antenna is configured to respond to frequencies within the range of 700 megahertz to 960 megahertz, 1700 megahertz to 2700 megahertz, 3400 megahertz to 3800 megahertz, and 5100 megahertz to 5900 megahertz.

20. A method comprising:
forming a loop antenna having a first corner between a first side and a second side and a second corner between the second side and a third side;
forming a loop fed inverted F antenna including the loop antenna and a first arm extending from the second corner of the loop antenna, the first arm configured in parallel with the second side of the loop antenna and in parallel with the first side of the loop antenna and forming a corner proximate to the first corner of the loop antenna; and
forming a monopole antenna coupled to the first side of the loop antenna and extending in parallel with the first arm of the loop fed inverted F antenna.

21. The method of claim 20 wherein the first arm of the loop fed inverted F antenna forms an outer edge of a housing of an electronic device.
